(19) United States
(12) Patent Application Publication
(10) Pub. No.: US 2008/0017059 A1
(43) Pub. Date: Jan. 24, 2008

(54) Printing Press Fountain Supply and Turbo Dampener Cleaning

(76) Inventors: Paul B. Englram, Wooddale, IL (US); Brian Kaspari, Bolingbrook, IL (US)

Correspondence Address: JAMES N VIDEBECK, 1 S 376 SUMMIT AVE, COURT C, OAKBROOK TERRACE, IL, 60181, US

(21) Appl. No.: 11/765,917

(22) Filed: Jun. 20, 2007

Related U.S. Application Data
(60) Provisional application No. 60/832,796, filed on Jul. 24, 2006.

(51) Int. Cl. B41F 31/00; B41F 35/04

(52) U.S. Cl. 101/364; 101/425

(57) ABSTRACT

Commercial newspaper printing presses utilize an improved water or fountain solution supply apparatus to spray the solution onto dampening rollers. In the improvement a closed to the air fountain solution supply apparatus keeps the solution free of contaminants. A built-in turbo dampening roller cleaner eliminates the need to dismantle the turbo dampening assembly to clean same.

The invention relates generally to printing presses and, more particularly, to built-in apparatus for supplying fluid to and cleaning a device to apply fountain solution to a printing press. Applicants claim priority based upon U.S. Provisional application Ser. No. 60/832,796 filed Jul. 24, 2006, the contents of which are incorporated herein by reference.

### BACKGROUND OF THE INVENTION

Large commercial printing presses use a multitude of rollers, many such presses use as many ink rollers as water or fountain solution rollers. One such printing press is shown and described at U.S. Pat. No. 5,179,899 issued to Man Roland Machine AG on Jan. 19, 1993. Part of the use of a perforated roller carrying water thereon can be explained in this patent at col. 2, line 35 where it indicates “this device may be, for example, a washing device such as washing water, for example, applying a spray to form an ink repellant damping or water layer on the impression cylinder, thereby maintaining the already printed image on the substrate web.”

On many of these printing presses, such a device is known as a turbo dampener. As the turbo dampener is used, the device builds up with contaminants. These contaminants, build up to the turbo rotor, which supplies the fluid to the printing press. Additionally, these contaminants also build up in the water feed channel and components inside the turbo dampener. These contaminants may include paper dust, ink and bacteria. As printing press components become filled with contaminants, eventually they must be cleaned. Heretofore, this has meant dismantling the press and cleaning the various parts thereof, including removing the approximately 25 to 300 turbos in a typical newspaper printing plant and scrubbing the surface of the turbo and the turbo rotor and fluid supply parts until they are clean, then reassembling the printing press.

Down time with any production line apparatus greatly decreases the efficiency of the entire printing process. Having to remove and individually clean these printing press turbos and then again having to reassemble the printing press periodically, creates inefficiencies and labor intensive maintenance in what would otherwise be an efficient automated process. A need has developed for eliminating and/or preventing contaminant buildup in the turbo dampeners of commercial printing presses.

### SUMMARY OF THE INVENTION

It is therefore an object of the present invention, generally stated, to provide a new and improved apparatus for eliminating contaminants from the water feed system and rotor of a turbo dampening assembly in a large commercial printing press of the type used to print newspapers.

Another object of the present invention is the provision of an on-board apparatus for cleaning contaminants from a turbo dampening roller.

A further object of the present invention is the provision of an improved water feed apparatus that prevents the clogging of these components to a turbo dampener in a printing press free of contaminant build up.

The invention resides in a printing press in a fountain solution spreading or spraying apparatus for coating a dampening roller. The apparatus includes a housing mounted on the printing press and an elongate generally cylindrical rotor rotatably mounted on the housing. An elongate reservoir is mounted on the housing below and to the side of the rotor for receiving fountain solution. A bottom of the rotor is positioned to contact an upper surface of a fountain solution positioned in the reservoir for receiving the fountain solution thereon and spraying same toward a dampening roller on the printing press. The invention is directed to an improvement comprising a rotor cleaning apparatus including elongate means for cleaning the rotor reciprocally positioned spatially adjacent an outer surface of the rotor. The invention includes means for reciprocating the elongate cleaning means for positioning a distal end of the cleaning means in contact with the outer surface of the rotor and control means for operating the reciprocation of the cleaning means.

The invention is further directed to a closed to the air fountain solution supply apparatus including a flow meter and tubing, branch tubing and sometimes sub-branch tubing that provide equal distribution of the fountain solution to spatially related nozzles substantially equally spaced along the fountain solution reservoir.

### BRIEF DESCRIPTION OF THE DRAWINGS

The features of the present invention which are believed to be novel are set forth with particularity in the appended claims. The invention may best be understood from the following detailed description of currently preferred embodiments thereof taken in conjunction with the accompanying drawings wherein like numerals refer to like parts, and in which:

FIG. 1 is a vertical cross-sectional view of a presently existing turbo dampening rotor assembly;

FIG. 2 is a vertical cross-sectional view, similar to FIG. 1, of a turbo dampening rotor assembly constructed in accordance with the present invention;

FIG. 3 is and elevational view of the elongate turbo dampening cleaning assembly of the present invention;

FIG. 4 is an elevational view of a water supply apparatus for a three wide turbo dampener constructed in accordance with the present invention;

FIG. 5 is an elevational view of a water supply apparatus for a two wide turbo dampener constructed in accordance with the present invention.

### DETAILED DESCRIPTION OF THE PREFERRED EMBODIMENT

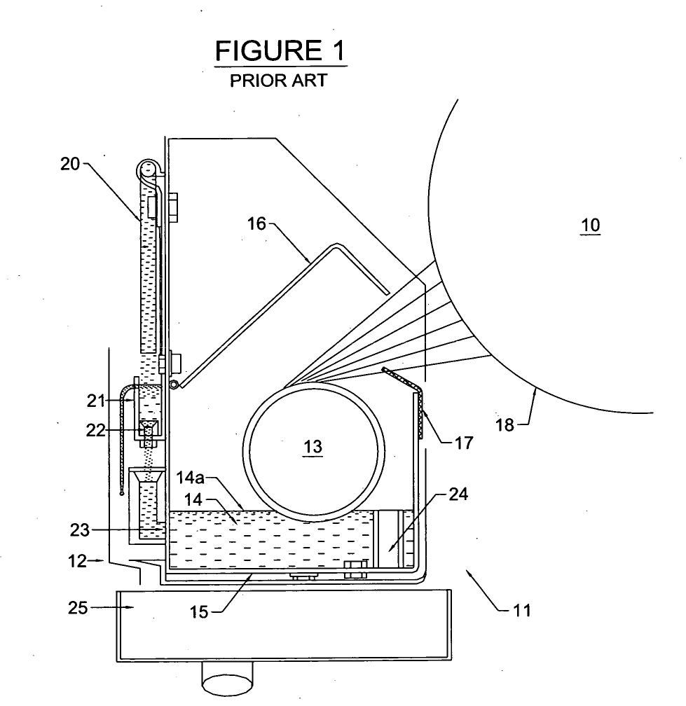

Referring to FIG. 1, a dampening take up roller, generally indicated at 10, is a part of the main water feed for a Man Roland printing press (not shown) but which can be seen diagrammatically in the aforementioned U.S. Pat. No. 5,179,899. Adjacent the dampening take up roller 10 is what is termed a turbo dampening assembly, generally indicated at 11, constructed in accordance with the heretofore existing prior art. This dampening assembly includes a housing, generally indicated at 12, an elongate rotor, generally indicated at 13 with the bottom thereof sitting in fluid 14 captured in a fluid reservoir 15 adjacent the bottom of the housing 12. The water dampening fluid 14, otherwise known as the fountain solution, wets the outside of rotor 13, which rotates at high speed to fling the fountain solution outwardly of the roller and through the open space under a shutter 16 and by a water deflector 17 at both ends of the roller onto the outer surface 18 of the dampening take up roller 10.

A pump (not shown) supplies fountain solution 14 to the reservoir 15 by means of a supply pipe 20 that leads into an open air, elongate overflow trough 21 that runs the length of roller 10 and from there through a plurality of evenly spaced metering bores 22 positioned along the length of the overflow trough 21 to each of a plurality of inlet pipe sockets 23 that lead into the side of elongate reservoir 15. On the opposite side of the reservoir 15, an overflow 24 assures that the top surface level 14a of the fountain solution remains constant. The overflow 24 leads to a return line trough 25.

In operation, when the turbo dampening rotor 13 and/or the open to the air fountain solution supply apparatus becomes contaminated enough to noticeably degrade the printing operation, the printing press (not shown) is shut down, the turbo is removed for cleaning of the rotor and water feed channel and then reassembled at which time the printing operation re-starts on line operation.

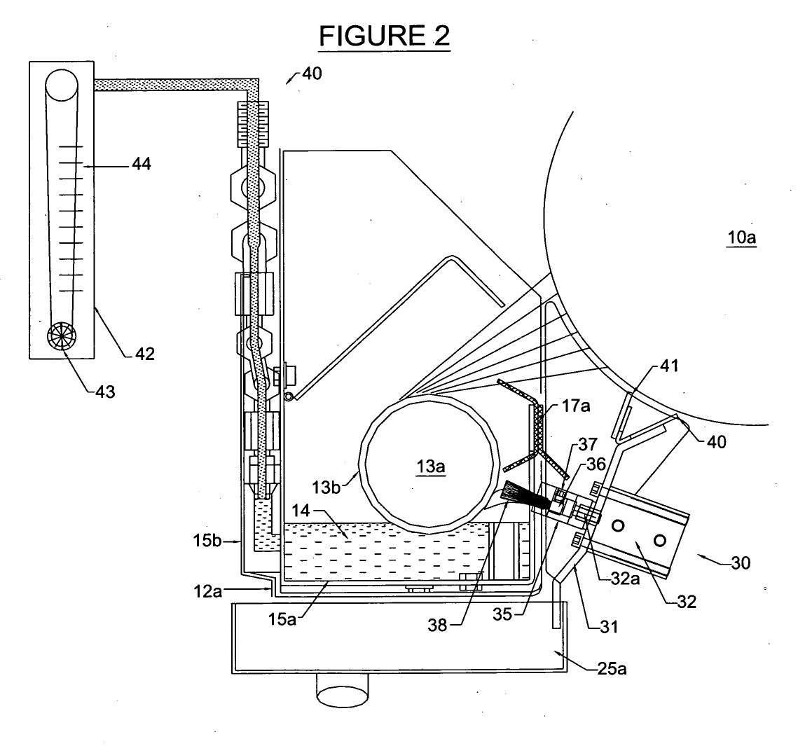

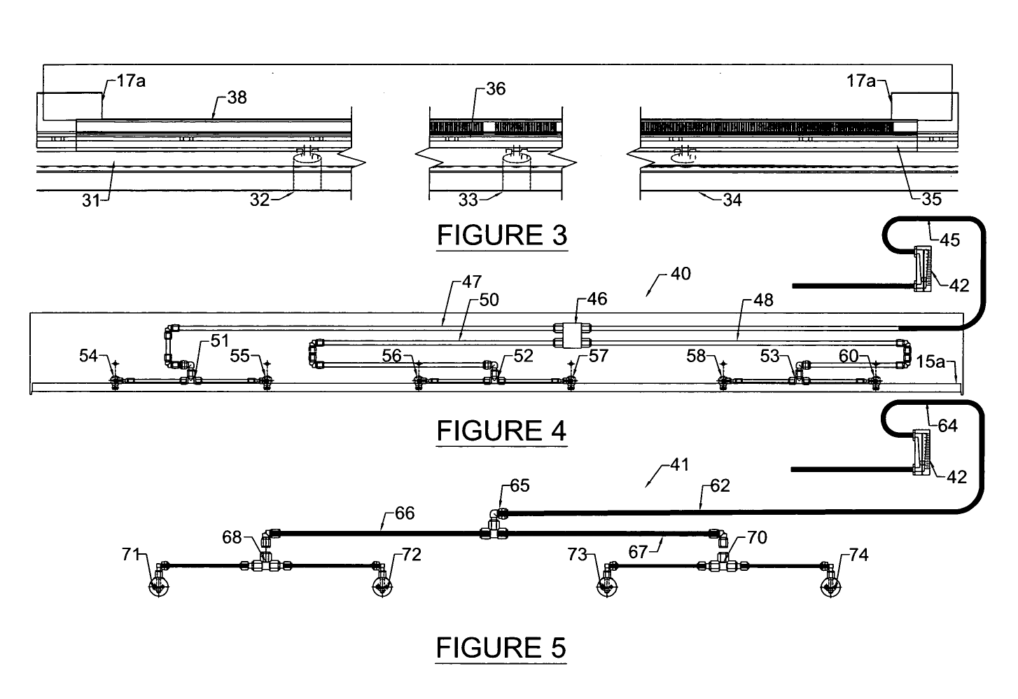

Referring to FIGS. 2, and 3, an improved on site turbo dampener rotor cleaning assembly, generally indicated at 30, is mounted on the housing 15a subjacent and between the water deflectors 17a-17a and between the housing 15a and the roller 10a. The turbo rotor cleaning system 30, constructed in accordance with the present invention, includes an elongate cylinder mounting brace 31 mounted on the housing so as to allow fountain solution 14 and contaminant particles (not shown) to drain into the return line trough 25a. Along the length of the cylinder mounting brace 31 are positioned a plurality (in this embodiment 3) of pneumatic cylinders 32, 33 and 34, each pneumatic cylinder includes a piston 32a, 33a, 34a respectively, extensible reciprocatively therefrom. Each piston in turn is mounted to an elongate bracket 35 that includes an elongate recess therein in which the elongate base of the brush 36 is positioned and retained by fasteners 37-37. The brush includes a plurality of bristles 38 extending from the base of the brush toward the roller, 13a.

In operation, during cleaning, the rotor 13a is rotated at a slower speed than when it is flinging fountain solution onto the dampening roller 10a. The pneumatic cylinders 32, 33 and 34 are operated at a predetermined pressure to force the pistons outwardly thereof and position the brush bristles 38 against the outside surface of roller 13a as it rotates. Contaminants from the outside surface of the roller 13a may fall into the return line trough or get stuck on the bristles 38 and be removed manually therefrom. The pistons 32a, 33a and 34a (only one shown) has sufficient unused travel, as originally set up to make up for wear in the bristles 38 as they may become shorter during long use. The pressure in the pneumatic cylinder determines the force the brush bristles 38 apply to the outer surface 13b of rotor 13a and is adjustable so as to provide for adequate cleaning. Adjacent the top of the cylinder mounting brace 31 is a wiper blade mount 40 that has a wiper 41 adjustably positioned thereon to assure a proper amount of fluid solution is deposited upon the dampening take up roller 10a.

Referring to FIGS. 2, 4 and 5, the improved fountain solution supply assembly, generally indicated at 40, includes six distribution hubs in a triple wide printing press with a roller length of approximately 70″-85″ for which the fountain supply side assembly 40 is configured as shown most clearly in FIG. 4. A double wide printing press utilizes the supply side assembly shown at 41 for a roller length of approximately 48″ to 58″. A narrower single wide printing press, utilizes the supply side assembly shown at 41 for a roller length of approximately 23″ to 36″. All three assemblies utilize a flow meter 42 having a metering valve 43 and a display 44 thereon. The flow meter can be replaced with another type of flow control device such as a flow controller or orifice. In the preferred embodiment from the flow meter 42, which is the same for each supply apparatus, a ⅜ inch outside diameter output line 45 in the six hub assembly 40, proceeds to a position not quite half way along the length of the reservoir 15a on the back bracket 15b of the housing 12a where it flows into a four way tube fitting 46. From fitting 46, three ⅜ inch outside diameter outlet lines 47, 48 and 50 each lead to T-couplings 51, 52 and 53 respectively, that branch with ¼ inch outside diameter tubing to distribution hubs 54, 55, 56, 57, 58 and 60 that are evenly spaced at about 12 inch intervals along the reservoir and are at the same positions as the inlet pipe sockets 23 shown in FIG. 1.

The fountain solution feeding system 40 is engineered to deliver even flow to each of the distribution hubs to create a substantially level flow of fluid to the reservoir.

Referring to FIG. 5, the double wide fountain solution distribution assembly 41 preferably includes a ⅜ inch outside diameter feed line 64 from the flow meter 42 that feeds approximately half way along the length of the double wide turbo damping roller 13a into a T-shape fitting 65 which divides the flow of fluid evenly into two ⅜ inch outside diameter lines 66, 67 that also flow through T couplings 68, 70 into four ¼ inch outside diameter like length lines feeding into evenly spaced (about 12 inches apart) distribution hubs 71, 72, 73 and 74 that feed into the fountain solution reservoir of the double wide length roller, similarly to the 6 wide apparatus shown in FIG. 4.

A preferred material for the tubing is thin walled stainless steel, although other materials such as polyethylene can be utilized within the scope of the present invention. Also the tubing diameters may be varied. By eliminating the open air portions of the prior art fluid supply assembly, contaminants in and around the fountain solution are eliminated on the supply side at least until the solution enters the reservoir 15a. Elimination of contaminant collecting open air troughs in the fluid supply assembly substantially lessens the necessity of down time for cleaning out the turbo dampening portion of the printing press. Others have tried to improve on the old, open air trough 21 by adding a cover and other modifications, but this has not proven to be as effective as the tube system that is described herein.

Thus, a new and improved turbo dampening cleaning assembly and supply side fountain solution feed assemblies for both 2 wide and 3 wide printing presses have been shown and described. It will be understood by those skilled in the art that modifications and changes may be made from the disclosed embodiments within the scope of the present invention. It is the purpose of the appended claims to cover such modifications and changes.

What is claimed:

1. In a printing press, a fountain solution spreading or spraying apparatus for coating a dampening roller, said apparatus including:
a housing mounted on said printing press,
an elongate, generally cylindrical rotor rotatably mounted on said housing,
an elongate reservoir mounted on said housing subjacent said rotor for receiving fountain solution therein, a bottom of said rotor positioned to contact an upper surface of any fountain solution positioned in said reservoir for receiving said fountain solution thereon and spraying same toward a dampening roller on said printing press,
an improvement comprising:
a rotor cleaning apparatus,
elongate means for cleaning said rotor reciprocably positioned spatially adjacent an outer surface of said rotor.
means for reciprocating said elongate cleaning means for positioning a distal end of said cleaning means in contact with said outer surface of said rotor, and
control means for operating the reciprocation of said cleaning means.

2. The printing press as defined in claim 1 further including:
fountain solution supply means on said housing for providing an enclosed delivery path between a flow control apparatus and said elongate reservoir.

3. The printing press as defined in claim 2 wherein said fountain solution supply means include
a fountain solution source line,
at least two branch lines extending from said source line substantially evenly dividing said fountain solution flow to a respective plurality of evenly spaced inlets along the length of said reservoir.

4. The printing press as defined in claim 3 further including a plurality of sub-branch lines with at least two such sub-branch lines extending from each branch line to substantially evenly divide said flow of said fountain solution from each said branch line.

5. the printing press as defined in claim 1 wherein said elongate cleaning means includes,
an elongate base,
a plurality of bristles extending from at least one side of said base generally toward said elongate rotor.

6. The printing press as defined in claim 1 wherein said means for reciprocating said elongate cleaning means includes,
at least one pneumatic cylinder mounted on said housing, a piston on said pneumatic cylinder being in operative connection with said elongate cleaning means.

7. The printing press as defined in claim 6 wherein said housing includes a member extending therefrom for providing a mounting for at least one pneumatic cylinder.

8. In a printing press, apparatus for supplying fountain solution to an elongate reservoir, an improvement comprising,
means for metering fountain solution to said reservoir,
first means for substantially equally dividing said fountain solution flow,
a main fountain solution conduit closed to the air extending from said metering means to said first dividing means,
second means for substantially equally dividing said fountain solution flow, and
at least two branch fountain solution conduits closed to the air extending from said first dividing means to substantially equally spaced openings at said reservoir.

9. In a printing press, apparatus for supplying fountain solution to an elongate reservoir, an improvement comprising,
means for metering fountain solution to said reservoir,
first means for substantially equally dividing said fountain solution flow,
a mean fountain solution conduit closed to the air extending from said metering means to said first dividing means,
second means for substantially equally dividing said fountain solution flow,
second means for substantially equally dividing said fountain solution flow,
at least two branch fountain solution conduits closed to the air extending from said first dividing means to said second dividing means,
at least four sub-branch fountain solution conduits closed to the air extending from said second dividing means to substantially equally spaced openings at said reservoir.
